(19) United States
(12) Patent Application Publication
(10) Pub. No.: US 2002/0091546 A1
(43) Pub. Date: Jul. 11, 2002

(54) Point of care

(75) Inventors: Dimitri A. Christakis, Seattle, WA (US); Robert L. Davis, Seattle, WA (US); Frederick P. Rivara, Seattle, WA (US); Jeffrey A. Wright, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: University of Washington

(21) Appl. No.: 09/760,372

(22) Filed: Jan. 11, 2001

(51) Int. Cl. G06F 7/00; G06F 17/60; G06F 17/00

(52) U.S. Cl. 705/2; 707/104.1

(57) ABSTRACT

A computer-implementable method and apparatus provides concise bits of information at the point of care within the confines of a provider-patient relationship. Interactive computer screens display information to the provider in the form of selectable indications, drugs, methods and evidence-based articles. Health care organizations may integrate this computer-implementable method into the general work flow of patient care to provide timely information to the provider. The computer-implementable method and apparatus may be integrated into existing health care patient systems or may be instituted as a stand-alone application. The computer-implementable method allows the provider to drill down for digestible bits of information, within the system, to receive information at levels conversant to the need of the given situation in patient care. At any time, the provider may choose to receive more comprehensive bits of knowledge or have the information electronically mailed for later study. Integrated within the main point of care information system is a computer-implementable method used to write prescriptions for patients. The prescription writer permits the provider to either manually enter the prescription based on the original drug selection or lets the computer-implementable method issue a prescription. The prescription writer issues prescriptions based upon rules set forth in the computer-implementable method regarding dosing of a previously chosen drug and the patient information available to the computer-implementable method.

### FIELD OF THE INVENTION

The present invention relates to the practice of evidence based medicine in a clinical setting, and more particularly to providing evidence based medicine at critical junctures in patient care.

### BACKGROUND OF THE INVENTION

The classical approach to medical treatment has always revolved around identifying the problem that a patient has described. Before evidence-based medicine, problem management was done by a provider using the experience garnered over years of training, career experiences or asking a trusted colleague. The other option was to read a reference text or read a review to aid in the treatment of a condition. As is evident by the above description, there are holes in the knowledge of each practitioner, with little or nothing to conclusively aid in validating the original supposition of treatment in a conclusive forthright manner.

Providers are constantly faced with interpreting diagnostic tests, the efficacy of preventive or treatment intervention, the harm associated with a specific drug and the course and prognosis of the disease in a particular patient. A provider must know whether advice in practice guidelines is sound and whether the conclusions from systematic reviews are valid.

Evidence based medicine is the conscientious, explicit and judicious use of the most current and best evidence used in making decisions about the care of individual patients. Currently, modern practitioners are in desperate need of implementing this form of medical knowledge into the day-to-day activities of a practice.

Current practice of evidence based medicine combines the best available clinical evidence available from systematic research. Clinically relevant research, often from the basic sciences, but primarily from patient centered research into the accuracy and precision of diagnostic tests (including the examination) and into the efficacy and safety of treatment, rehabilitative and preventative regimens, form the basis for the best evidence.

The present methodology used in evidence based medicine is to gather information from locales on the web or from articles put forth from the Cochran Collaboration, as well as other medical periodicals such as JAMA (Journal of the American Medical Association). Unfortunately, information gathered through the web and other print media is slow at best and fails to find relevancy, incumbent upon searching through large volumes of information. To tie evidence-based medicine in with a busy practice is particularly difficult in today's medical arena due to the incredible workloads experienced in most clinical environments. Doctors with an active patient load simply do not have the time to do research, absorb and apply evidence-based medicine in an efficient manner using the tools available in today's clinical setting.

An effective mechanism for bringing about the reality of evidence-based medicinal techniques has eluded those skilled in the art. Accordingly, a need exists for a system or method for practicing evidence-based medicine in a clinical environment. Care should be taken, never disrupting the workflow, but rather, placing into the work environment the tools necessary to enhance it, while continuing to bring the effectiveness of treatment to patients. Doing the above will help insure patients better care based on the best available evidence-based medical knowledge of not just the practitioner but also that of the medical community as a whole.

### SUMMARY OF THE INVENTION

This invention broadly relates to a method and apparatus for providing information to a service provider that is in the process of making a decision as to a treatment regimen to be followed, in a manner that does not interfere with the normal workflow used by the service provider.

In accordance with an embodiment of the present invention, a computer-implementable method and apparatus for the interactive display of evidence-based medicine is used to present a provider with digestible bits of information at the point of care in a health care setting. Briefly described, the invention provides an environment whereby a health care provider is capable of retrieving the most current and best evidence-based knowledge at critical junctures in patient care in a timely manner. The health care provider accesses the system by selecting the patient record. From selection of the patient record, indications and medications are selected. At the time of selection, critical article summaries are presented to the health care provider in levels that are decided upon by the health care provider. References to presented articles may be e-mailed for later study. From the information presented, a health care provider may act upon the given information and write the prescription by automatic means as determined by rules set forth in the system or by manual means.

More specifically, the computer-implementable method provides a means of presentation, on a scaled basis, through the use of a computer application interface in such a way as to present the provider with a linear progression of screens following rules of evidence integration during the prescription writing process. One essential aspect of the design and implementation is the application provider interface. The application provider interface will model the theory of evidence-based medicine by allowing the provider to chose the drug and conditions, presented in list format, then leading the provider through further steps which will validate the existing choices of the provider. After the selection of a drug and conditions, the provider is presented with a summary of evidence with the option to retrieve more evidence, which is entirely conditional on the desire of the provider to seek more evidence based on the original summary of evidence. This procedure allows the provider to receive small digestible bits of information with increasing levels of detail on demand as the provider requests such information. At any point after the original presentation of the summary of evidence, the provider can abandon the search for more evidence and write the prescription.

In an alternate embodiment of the present invention, the computer-implementable method, comprised of the application interface, may present the theory of evidence-based medicine by allowing the provider to chose the drug and conditions, presented in list format, then leading the provider through further steps which will validate the existing choices of the provider, without the need to select a patient or be associated with a patient in any manner. This alternate embodiment to the present invention allows for a provider to accomplish research without regard to patient conditions. In this manner, the present invention can be used as an exemplary tool for educating medical staff in evidence based techniques in addition providing a platform for research for experienced clinicians.

In one aspect of the present invention, the computer-implementable method addresses workflow related issues encountered within a health care organization. The present invention seeks to assert the timeliness of information at critical junctures during patient care. During the day-to-day activities in a health care organization, the result of patient care is a prescription. By providing information at the time a prescription is written, the actual real-time use of evidence-based medicine in daily practice for health care professionals is enabled.

In another aspect of the present invention, the computer-implementable method links patient-related data with the prescription writing process. The prescription writer permits the provider to either manually enter the prescription based on the original drug selection or lets the computer application issue a prescription based upon rules set forth in the computer application regarding dosing of the previously chosen drug and the patient information available to the computer application. The result of this process is to issue a prescription for use by the patient in a clear, annotated and reproducible format.

In an alternate form of the present invention, the computer-implementable method can process lab or radiology reports linked to patient-related data. By linking lab or radiology reports to the present invention patient lab tests and radiology examinations can be ordered based on the best available clinical research available, following evidence based medicine practice. In addition to ordering lab tests and radiology examinations, treatment regimens may be generated for the patient, in the form of instructions given, by selecting treatment methods associated with evidence based medicine treatments.

In another aspect of the present invention, the computer-implementable method provides for the creation and storage of critical topics as used in summary evidential screens and for further informational screens as used in a computer application. The purpose of this computer-implementable method is to create a hierarchical set of documents set forth in a computer application as a complete set of documents regarding a particular condition and drug. This methodology allows for the formation of rules regarding the expanded bits of information made available to the provider as it is applied within a computer application.

In yet another aspect of the present invention, the computer-implementable method provides for progression of evidence to occur in a drill down fashion by allowing for information to be retrieved in a fashion conversant with the provider's ability to assimilate knowledge. The above is made possible through logical steps provided within the computer-implementable method, whereby the provider is led to distinctions of evidence so that choices may be made quickly and with clarity regarding the proper avenue to take in the process. This procedure is accomplished by displaying screens whereby selections made will lead the provider back to the prescription writer.

In a further aspect of the present invention, a computer-implementable method is provided to interface with any existing patient data systems. Many health care systems have active patient care systems. It is the intent of this computer-implementable method to interface with such systems to retrieve or supply information regarding patient data from or to such systems.

Additional aspects of the present invention call for continual input of evidence-based medicine information to the system. Information can be passed to the system by computer-implementable means involving current data transport techniques. Servers may be employed and used to update the system through the Internet, internal networks or by disk storage means.

The principles of the invention can be readily extended to work-flows and treatment and repair regimens in settings other than the health care field. One example is the process of real-time diagnosis and repair of products, such as automobiles, in which the service provider is a mechanic that is presented with a failure resulting in a number of potential repair strategies. Another example is the provision of legal advice and services by a lawyer, who must access in a very short time numerous primary and secondary authorities relating to solutions to a specific legal problem.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an operating environment illustrating the point of care system in accordance with one embodiment of the present invention;

FIG. 2 is a block diagram illustrating several of the components comprising a point of care system;

FIG. 3 is a sequence diagram illustrating the relationship of the databases, which reside on the point of care system;

FIG. 4 is a overview flow diagram illustrating the process employed by one embodiment of the present invention for filling a prescription while viewing evidence based medicine;

FIG. 5 is an overview flow diagram illustrating a subroutine employed by one embodiment of the present invention for handling indications;

FIG. 6 is an overview flow diagram illustrating a subroutine employed by one embodiment of the present invention for handling evidence and rules;

FIG. 7 is an overview flow diagram illustrating a subroutine employed by one embodiment of the present invention for handling dosage selection;

FIG. 8 is an overview flow diagram illustrating a subroutine employed by one embodiment of the present invention for handling standard dosing and prescription filling;

FIG. 9 is a flow chart illustrating the display process for selecting a patient, condition and indication and finally checking if evidence based information is listed for the selected indication in accordance with one embodiment of the present invention;

FIG. 10 is a flow chart illustrating the display process for evidence selection and sending email in accordance with one embodiment of the present invention;

FIG. 11 is a flow chart illustrating the display process for displaying a form and selecting prescription parameters in accordance with one embodiment of the present invention;

FIG. 12 illustrates an exemplary interface display screen for selecting a patient as used in daily practice;

FIG. 13 illustrates an exemplary interface display screen for selecting a patient condition as the primary complaint of the patient;

FIG. 14 illustrates an exemplary interface display screen for selecting a medication associated with a condition as the primary complaint of the patient;

FIG. 15 illustrates an exemplary interface display screen for selecting a patient indication as determined by the provider;

FIG. 16 illustrates an exemplary interface display screen for the provider to manually enter the indication for primary complaint of the patient;

FIG. 17 illustrates an exemplary interface display screen for selecting standard dosing for a patient the patient; and

FIG. 18 illustrates an exemplary interface display screen for the display of evidence based medicinal information with selections for increasing levels of evidence and an email option for sending email to the provider regarding evidence held within the system.

### DETAILED DESCRIPTION OF THE PREFERRED EMBODIMENT

As summarized above, the present invention allows for evidenced-based medicine to be practiced in an environment conducive to providing effective care to patients while providing the best known medical evidence to providers for treatment of said patients at points of critical care. With reference to the drawings, in which like numerals indicate like elements throughout the several figures, embodiments of the invention will are discussed in detail below.

Overview of the Operating Environment

The following discussion provides an overview of a point of care environment in which one embodiment of the present invention is employed. This discussion is intended to provide the reader with an understanding of the broad functionality of one point of care environment that makes possible the advantages of the present invention.

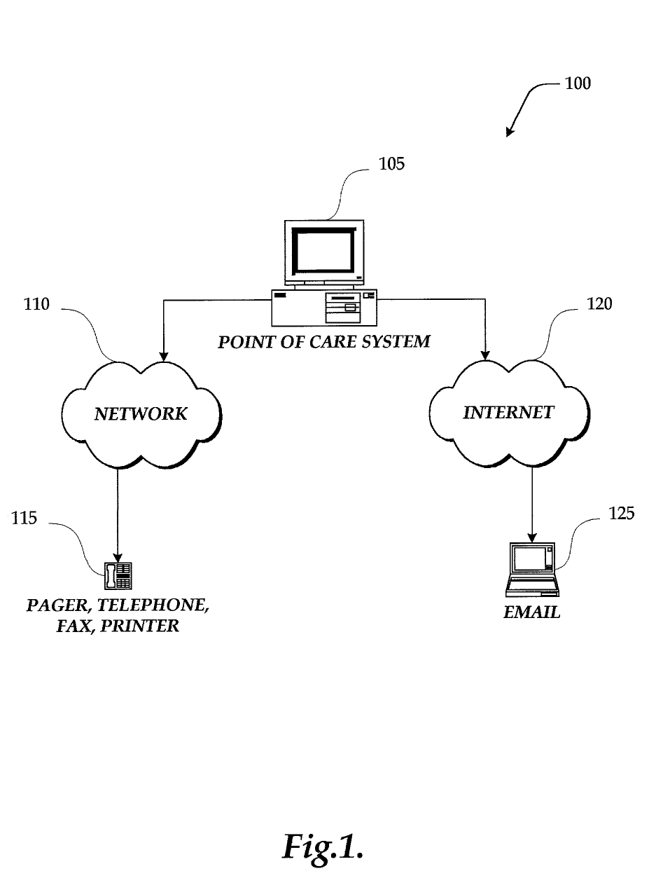

FIG. 1 is an operating environment representative of one embodiment of the present invention. Illustrated in the operating environment are two networks, the Network 110 and Internet 120. In the present invention, the Network 110 may comprise standard connections, such as a printer, various telephony devices and any other connecting 115 means. The Internet 120 is illustrative of using email 125 to send articles and other references as described in detail later in this overview.

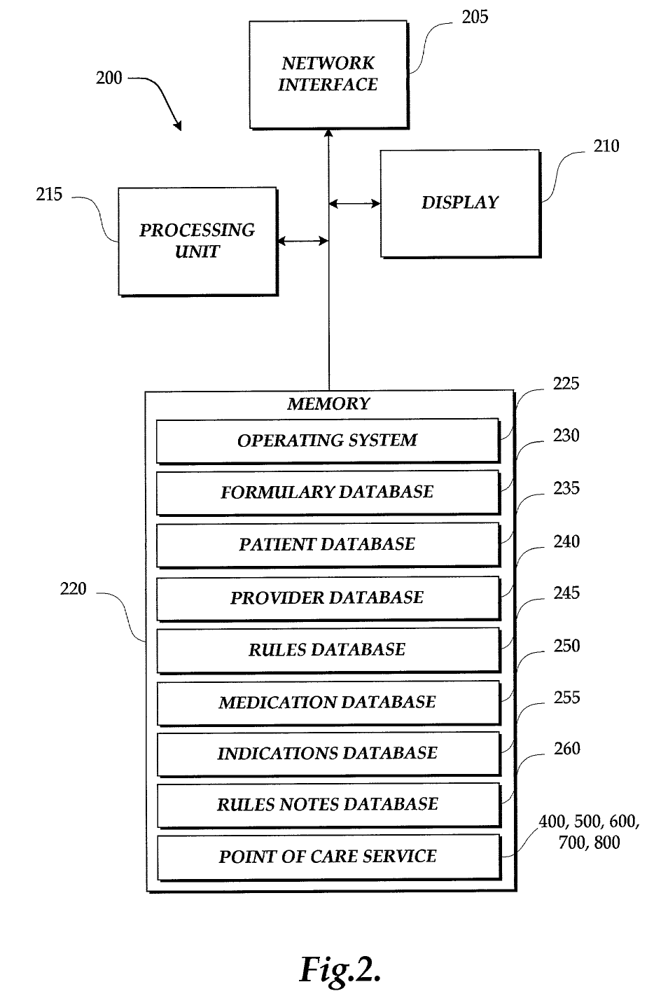

FIG. 2 is an exemplary illustration of the operating environment employed in the present invention. The system is comprised of a relational database, as defined in the formulary, patient, provider, rules, medication, indications and rules notes databases 230-260. The point of care service 400-800 is the main application, which uses the relational database for all storage and retrieval of information. In one embodiment of the present invention, a network interface is provided so that existing systems may be tied into the present invention for information retrieval by such means as ODBC SQL or HL7 messaging. The network interface can integrate with other modules of an outpatient clinic information.

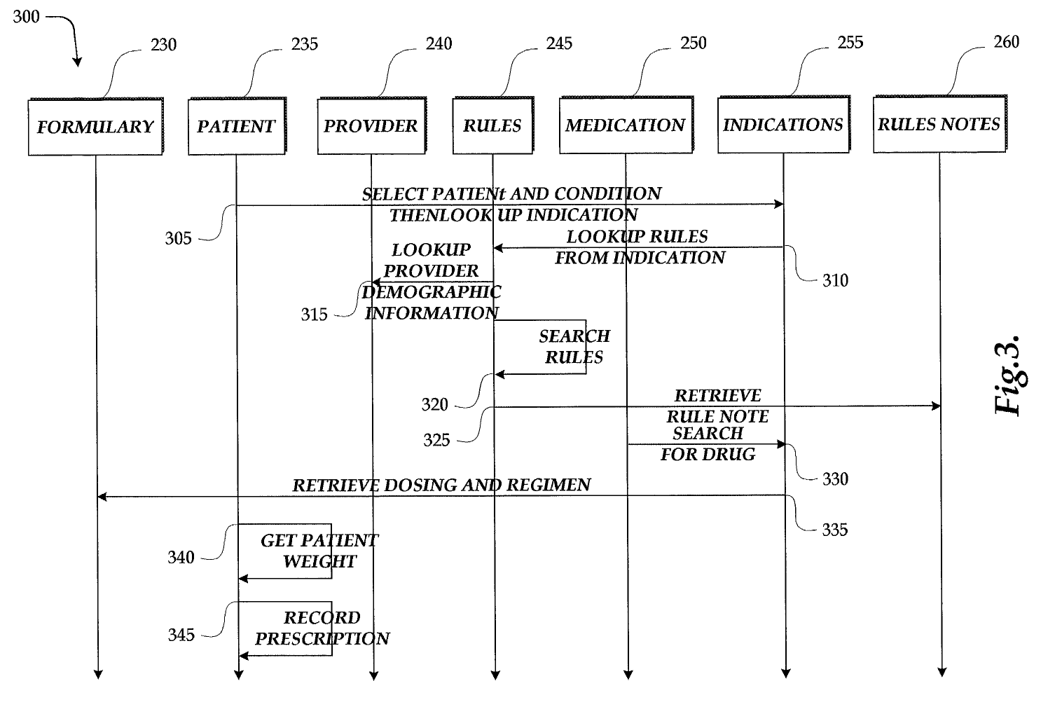

Each database within the relational database serves a particular function and when taken as a whole, represents one embodiment of the present invention. The formulary 230 database stores information, such as drug name and formulary information, some of which includes: dosage, regimen, etc. The patient database 235 contains information particular to each patient regarding information pertinent to writing a prescription and sundry information used for accounting. The provider database 240 stores information on a provider. The rules database 245 contains the particulars to each drug and interactions as defined by critically assigned topics. The medication database 250 contains information on all medications used within the system. The indications database 255 stores information on current indications as used by the system. The rules notes database 260 contains information presented to the provider once a rule is triggered. FIG. 3 exemplifies the relationship between individual databases used in the present invention. The process starts at label 305 where the provider selects a patient from the patient database 235. The information is passed to the indications database 255 where the current information on that indication is queried. Based on the indication information, a lookup 310 in the rules database 245 is performed regarding applicable rules. A lookup of provider demographic information 315 is accomplished in the provider database 240. Processing continues with the rules database where rules 325 are searched so that a medication and treatment may be matched up correctly along with other aspects, such as condition and dosage. Rule note information 320 is searched to matched the rule retrieved 310. The corresponding rule note is displayed 325 to the user from information stored in the rules notes database 260 regarding the selections made in association with the patient. Based on the medication, the indications 330 database will search for an associated drug as listed in the medication 250 database. After these pieces have been put together the system will retrieve the dosage and regimen 335 from the formulary 230. The patient weight 340 is retrieved to aid in dosage calculation from the patient database 235. The final step is to record and print the prescription 345.

It will be appreciated by those in the art that this is only one implementation of a relational database that handles all information for the point of care system. Alternate means for several tables are easily implemented. An example is using a formulary provided by a third party or interfacing with an existing provider and patient database. With standards, such as ODBC, SQL and others, it is plausible that no database tables, other than rules, medication, indication and rules notes, need have connections to this system.

At the core of the overall system is information that is saved in relational databases regarding the best available evidence based medical knowledge available. Knowledge is generated outside the computer environment and formatted into the prescribed form for the system to use. Once the area of interest has been identified, information is gathered that is relevant and reviewed following accepted review practices, such as (but not limited to) those outlined in the JAMA (Journal of the American Medical Association) series on evidence based medicine and critically appraising the medical literature. Information may be generated from several possible sources for use in the present invention.

After the quality of information is established, the message chains for the system are written in such a manner as to facilitate a drill down approach for information retrieval. This drill down approach recognizes the necessity of digestible bits of information be provided to the provider to insure a level of information useable to a provider as they are able to use said information. Often providers do not have the time to read a complete clinical write-up while with a patient, but there is time for a summary of evidence presentation. The system allows the provider to receive information about the best evidence, as they are able to digest it.

A provider is presented with information in ever increasing bits. The first screen is a very short synopsis of information so that the provider may decide whether to pursue more information or accept a small tidbit of knowledge as given. The second screen the provider is presented with is a summary screen presenting the provider with baseline knowledge. The third screen begins to ascertain how much more knowledge the provider may need by presenting an abstract concerning the study and drawing conclusions. The fourth screen presents the actual article or study, so the provider may review it in its entirety. Finally, the provider may decide that there is not enough time for a full review, yet the information is important, so the article may be reviewed at a later date by being sent to a valid email address.

The overall scope of information, such as the short synopsis, summary screen, abstract and article are defined as evidence-based information within this system as each is a condensed format of a higher article referred to as the parent reference detailing evidence-based medical knowledge as is practiced in evidence-based medicine. In this manner the evidence-based information is considered to be offered in smaller portions to the provider with the ability to garner the information level most appropriate to the situation in a manner conducive to encourage the use of said evidence-based information. A synopsis of evidence-based information is a brief summary of an abstract for purposes of the present invention. A detailed analysis of the basic facts for an article or reference as used for evidence based medicine is considered to be an abstract for purposes of the present invention. Providing the original reference of an evidence-based medicinal study as detailed by an article or study documents is referenced as an article of evidence-based information for purposes of the present invention. Evidence Based Medicine (EBM) and evidence-based information are considered to be interchangeable within the present invention.

The prescription writer, included in the system, offers the medium in which evidence-based information is generated by the queries generated by the filling of a prescription and also offers the provider the best evidence at the time most needed, while fitting in with the natural workflow of a daily practice. The prescription writer is an integral part of this system in that it accomplishes all the major goals set forth for running a evidence-based clinical environment while not attempting to override the experience and knowledge of the provider seeing the patient.

The prescription writer starts with the daily schedule for a doctor, maintaining information about the basic needs for the patient. As patients are seen, the doctor chooses the patient from the schedule and may confirm the original condition or modify it as needed based on information learned during the examination of said patient. Alternatively, the doctor may choose the patient from the schedule and then make the diagnosis. From the condition chosen by the doctor the system leads a doctor to choose a medication which will result in evidence presentation regarding the indication based off of the medicine chosen. It will be appreciated that indication may be selected before medication in an alternate embodiment making for a versatile implementation of the present invention. Information is displayed to the provider through a computer interface. If the information is too little the doctor may drill down for more and accept the information or choose to ignore what is presented. In either case of acceptance or denial of information, the doctor is presented with the best available knowledge strengthening their own innate knowledge while aiding decision making regarding health care. Information presentation of evidence based medicine is concerned with factual and good information while recognizing the importance of the diagnostic ability and training of the provider reviewing the individual case. If the doctor chooses, the original prescription based on the presented evidence can be modified, changed, reset or another can be created at this time. Dosage, type regimen, quantity and refill amount completes the prescription. This is a baseline for the invention and merely illustrates that evidence based knowledge is provided to the doctor at the time when a prescription is written so as to cause as little interference in daily practice as possible while bringing evidence based medicine into daily practice. Some attendant advantages are that prescriptions made with a lack of knowledge can be modified and brought in line with what is known to work. Another advantage to the present invention is that typical medicines thought to be of great worth may be found to be clinically unreliable over a drug that has a clinically proven record of success as learned through evidence based medicinal practices.

Overview of the Display Environment

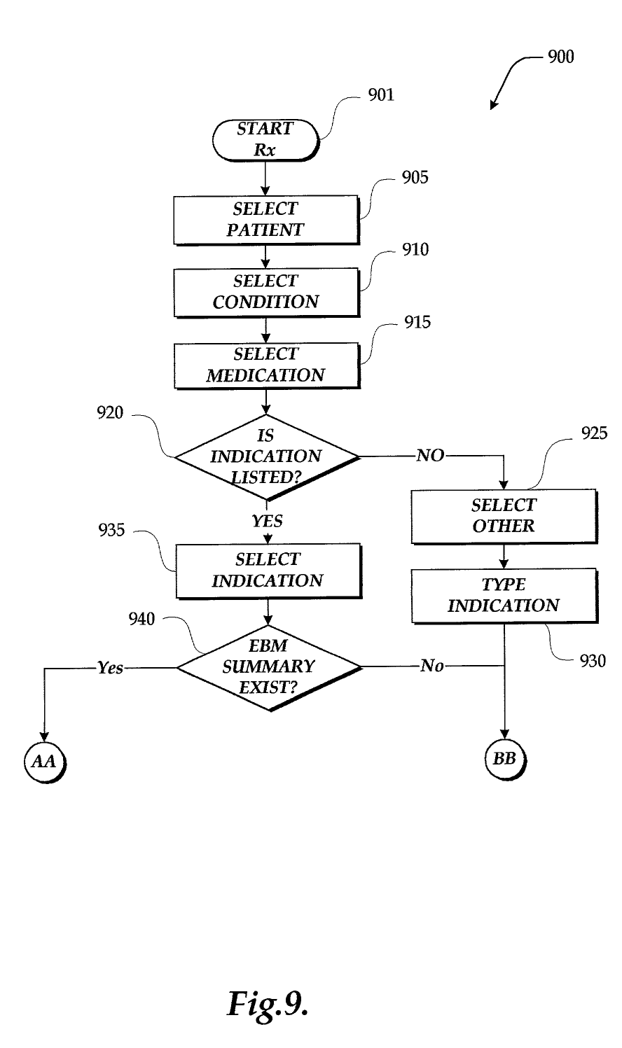

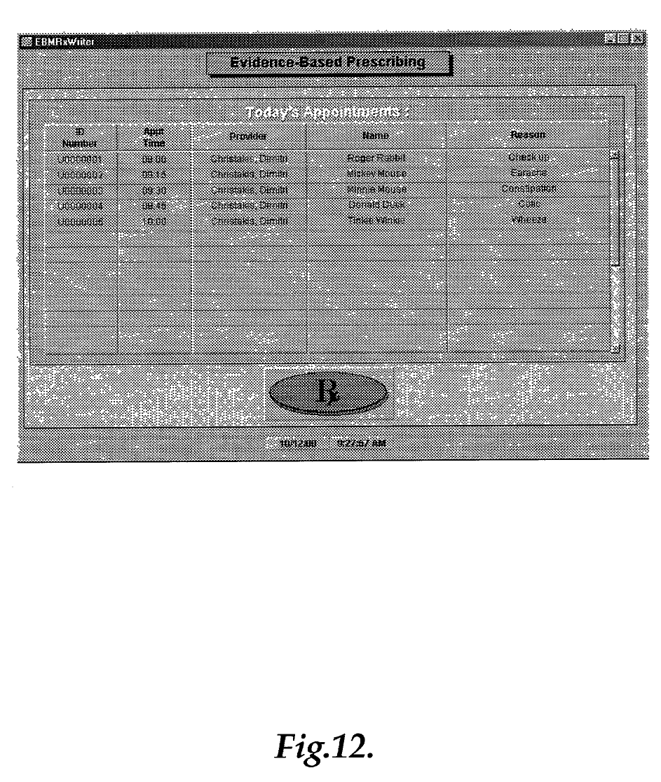

FIGS. 9-11 are functional operative diagrams representative of the point of care display environment illustrating one embodiment of the present invention. FIGS. 9-11 exemplify the point of care environment for generating a prescription at a critical junctures in patient care while giving the provider the best evidence based medical knowledge at a point most effective during treatment of said patient. FIGS. 12-18 are exemplary display screens representative of the point of care system and encompass one embodiment of the present invention. FIGS. 12-18 are representative of the environment on which the provider interfaces with the point of care system and when taken in consideration with FIGS. 9-11 a complete operative system is illustrated.

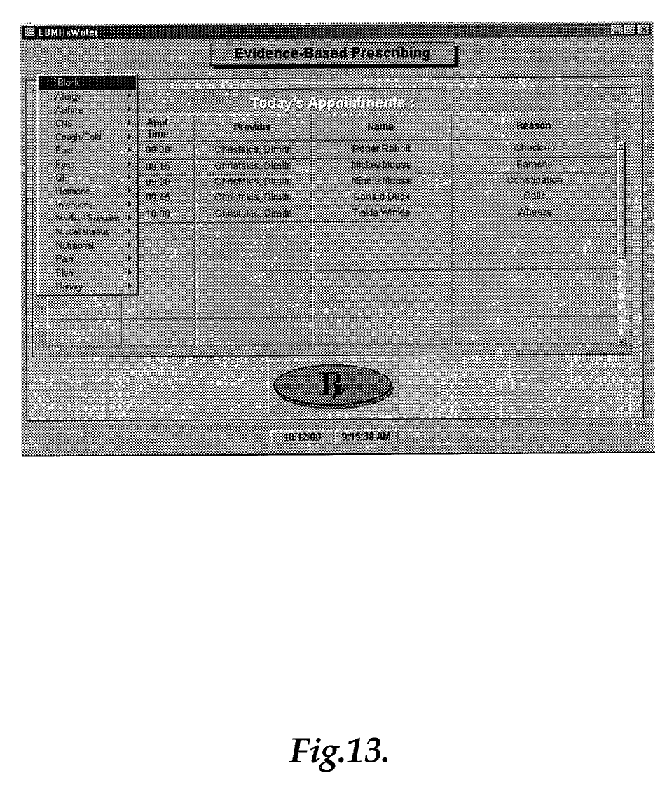

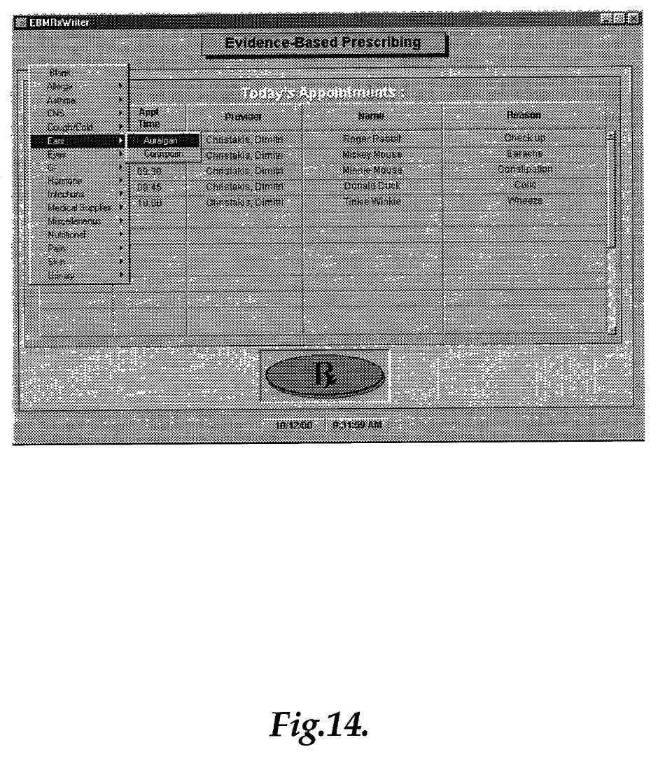

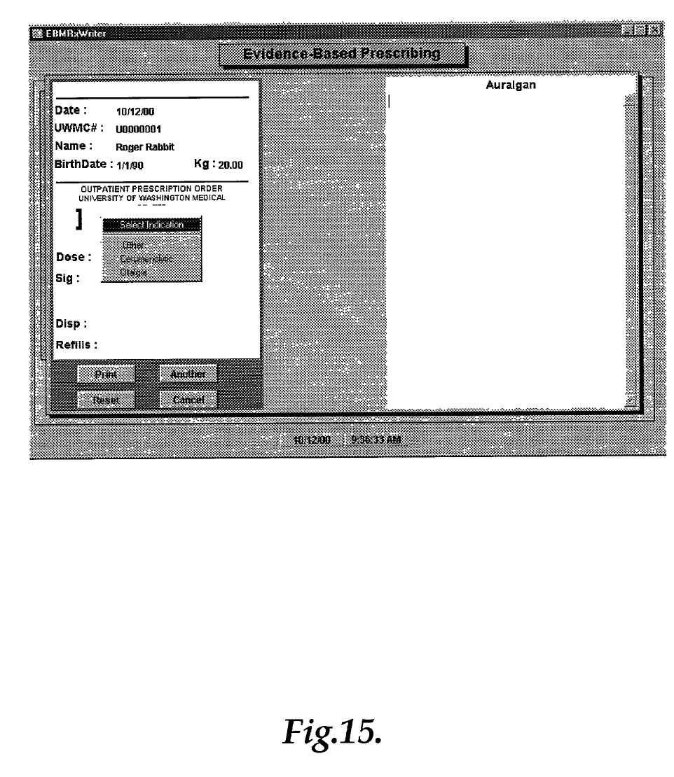

Starting with block 901 the point of care system is begun. At block 905, the provider is presented with a display for selecting a patient. A representative screen shot is found in FIG. 12. As soon as the patient is selected, the provider continues by pressing the RX button as illustrated in FIG. 12, which then displays a popup menu to the provider. This is equivalent to the display process moving from block 905 where the patient has been selected to block 910 where the condition for that patient is then selected. The menu displayed to the provider is shown in FIG. 13. From block 910, the process of selection screens moves on to block 915, which allows the selection of medication. The medication selection is a sub-menu to the condition menu. The sub-menu is illustrated in FIG. 14. After the medication is selected, the process continues with block 920. This is a logical block representative of a provider choice. If the indication is listed in the next screen after the medication selection, the display process continues with block 935 where the provider makes a selection regarding the indication of the patient. This screen is illustrated in FIG. 15.

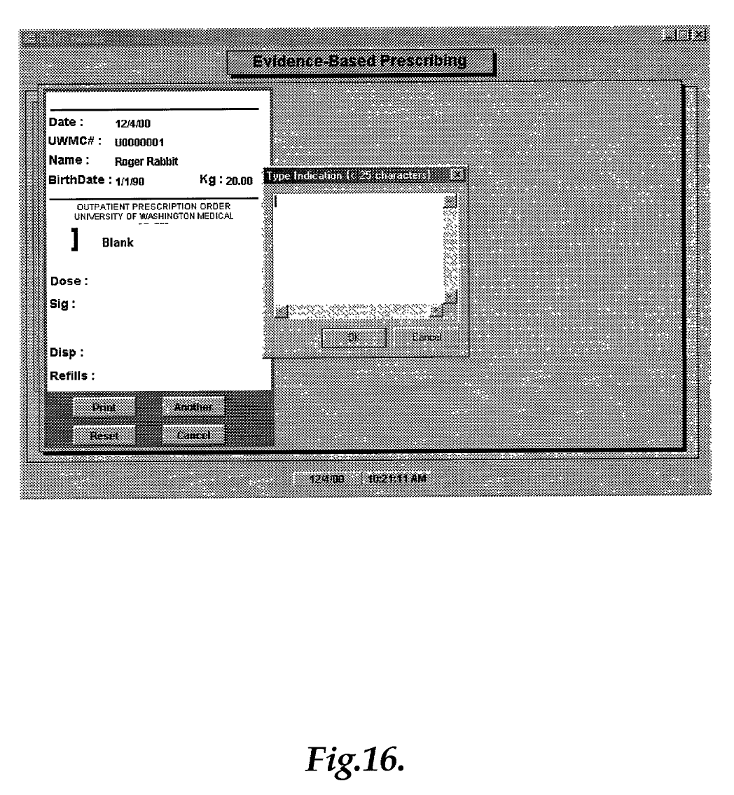

If there is no indication listed the provider will enter the information manually and a new popup menu is generated for the provider to enter the type of indication as illustrated in FIG. 16. This is a free form text box. The process follows from block 920, where a decision outside of the system is made, where the process continues by the provider selecting other, block 925, and having the type indication block 930 generate the popup. From block 930, the selection process for screens continues to block BB.

Continuing with the primary track of screens the indication is selected as shown in block 935 and an exemplary screen is shown in FIG. 15. The point of care system begins taking all the previously entered inputs and starts presentation of evidence based medicine displays.

If an evidence based summary exists, the process continues with block AA and if it does not exist, the process continues with block BB.

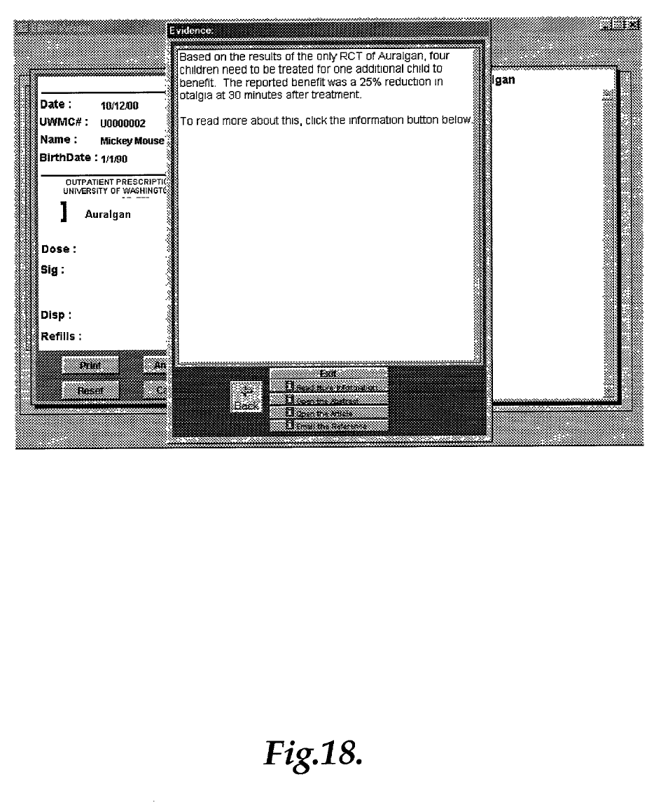

At block AA, the provider is led to block 1045 where the evidence is offered to the provider as exemplified in FIG. 18. The first screen the provider is presented with is a small one or more line summary of the evidence based medicine information stored within the system 1042. The provider may choose to bypass further screens and immediately write a prescription, in which case processing continues with block BB. The provider is capable of selecting the level of evidence they have the time or inclination to review under the particular circumstances they are faced with. The selections presented to the provider are shown by block 1050. Three selections are made available to the provider to offer significant digestible bits of information. Each selection represents an increase of information over the other, with the result being the study information. The starting screen gives a basic one or more line summation of available information. The first selection allows the provider to read more information. The second, termed “Read Abstract”, is the abstract of the critically appraised topic. The third, termed “Article”, is the actual article of the study providing a direct link to the entire subject matter.

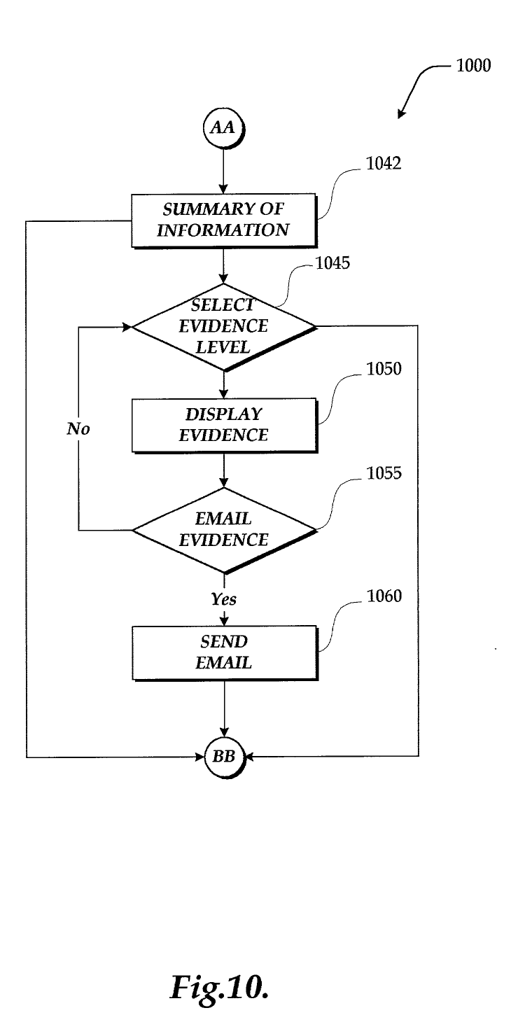

The screen illustrated in FIG. 18 shows that the provider may chose to email the evidence as shown in FIG. 10 by block 1055, which is representative of this decision making process. Should the provider wish an email, the process continues to block 1060, which then sends the referenced article to the provider for later review. The provider is able to press a button and have the reference to emailed to the providers email address. An email client, through a network sends email to the provider regarding the article. This allows the provider to review the article at leisure and to gather more information at a time when it may not be suitable to view all the information. It is obvious to those skilled in the art that email is not the only conduit for information to be read later. Such simple things as printing the article or saving the article for later can be appreciated as alternate means of transmission. The display process continues with block BB.

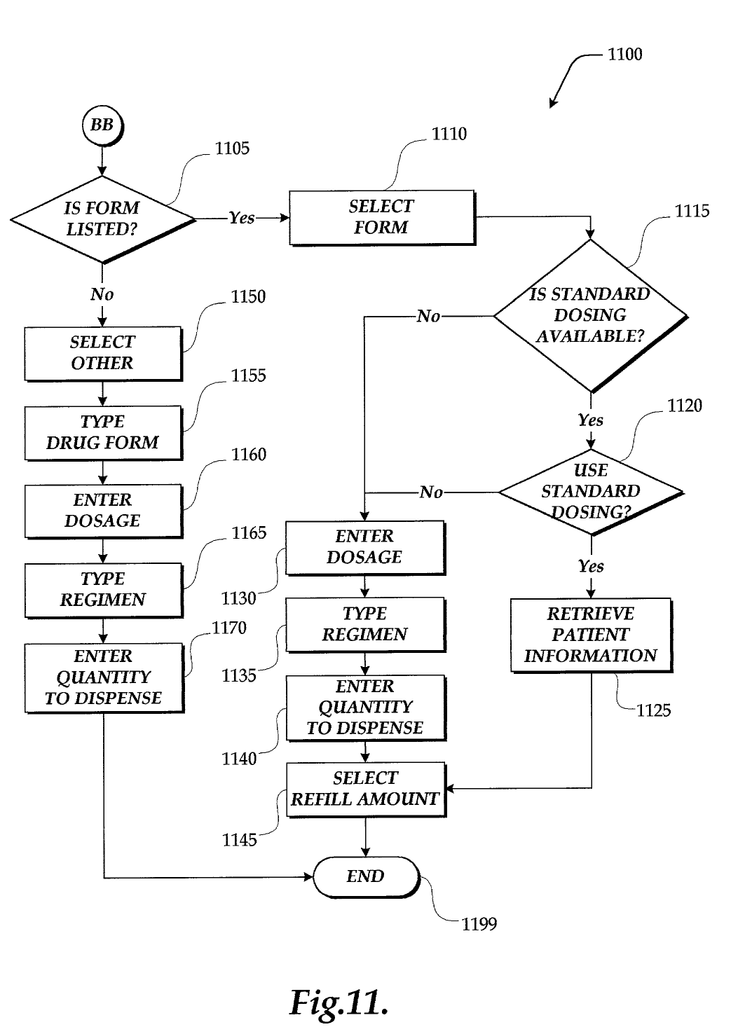

At block BB, the display process continues with FIG. 11, block 1105. After either the indication has been manually entered from block 935, no EBM or evidence-based information synopsis exists from block 930 or the provider decides to exit the evidential summary screen of block BB, FIG. 10, a popup menu displays a selection regarding the form of medication. Processing continues with blocks 1150 or 1110.

At block 1150, the provider selects “Other” from the popup menu to designate that there is no form available for that type of medication or that they wish to mandate a particular type of form not listed. Display processing continues with block 1155.

At block 1155, a popup text entry box allows the provider to enter in the specific type of drug. Display processing continues with block 1160.

At block 1160, a popup text entry box allows the provider to enter in the specific dosage for the selected drug. Display processing continues with block 1165.

At block 1165, a popup text entry box allows the provider to enter in the specific regimen for the chosen. Display processing continues with block 1170.

At block 1170, a popup text entry box allows the provider to enter in the specific amount of the drug for dispensing to the patient. Display processing ends with block 1199.

At block 1110, the provider selects the form of drug that is best suited for the given patient situation from one or more selections presented in the popup menu. Display processing continues with block 1115.

At block 1115, a popup window will occur if standard dosing options are available for the selected drug. If no dosing options are available, the provider will not see the popup menu. If no popup menu is available, proceed to block 1130, otherwise proceed to block 1120.

At block 1120, the provider is given the opportunity to choose standard dosing or manual dosing. A popup menu allows the provider to choose yes or no.

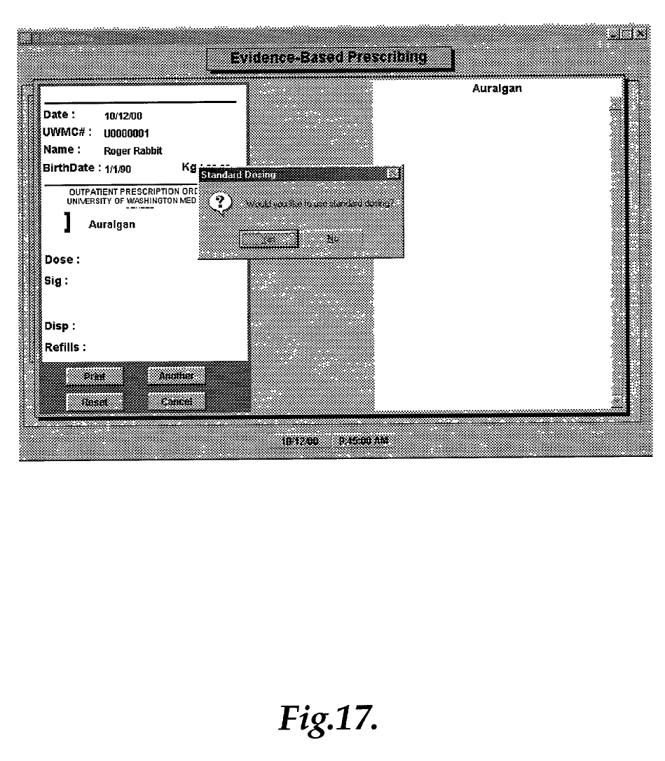

The popup decision process is illustrated in FIG. 17. If the provider decides to use standard dosing, proceed to block 1125, otherwise proceed to block 1130.

At block 1125, the patient information is retrieved and the standard dose is calculated based on the previously entered patient statistical information, such as the weight and age of the patient. Processing continues at block 1145.

At block 1130, a popup text entry box allows the provider to enter in the specific dosage for the selected drug. Processing continues with block 1135.

At block 1135, a popup text entry box allows the provider to enter in the specific regimen for the chosen. Processing continues with block 1140.

At block 1140, a popup text entry box allows the provider to enter in the specific amount of the drug for dispensing to the patient. Processing continues with block 1145.

At block 1145, a popup selection menu allows the provider to enter in the specific refill amount allowed for a prescription. Processing ends with block I 199.

Processes Employed by One Embodiment

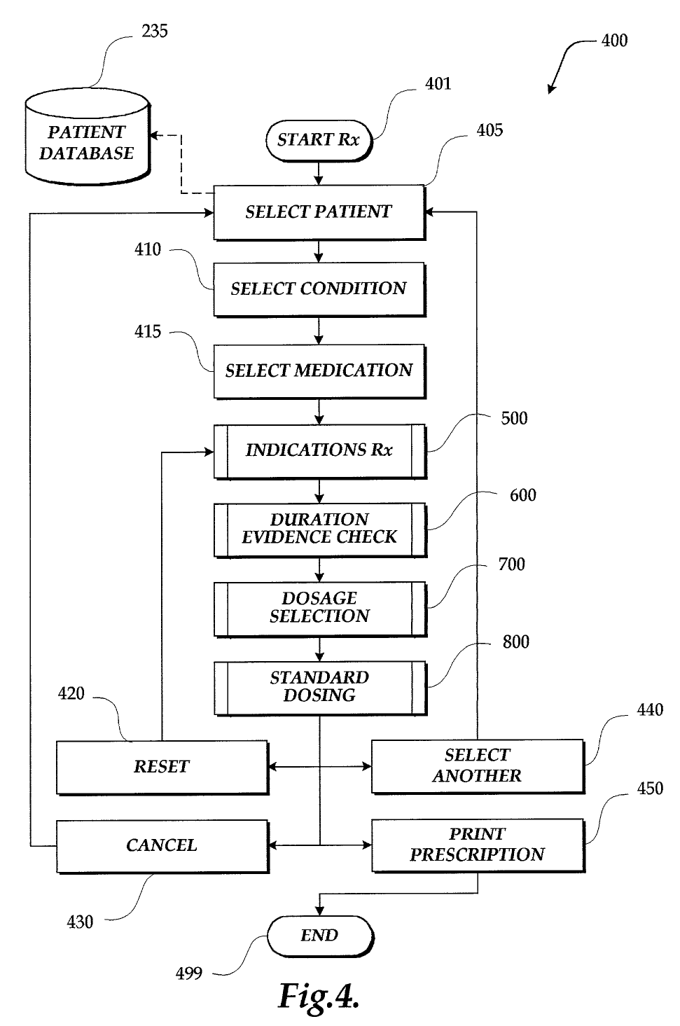

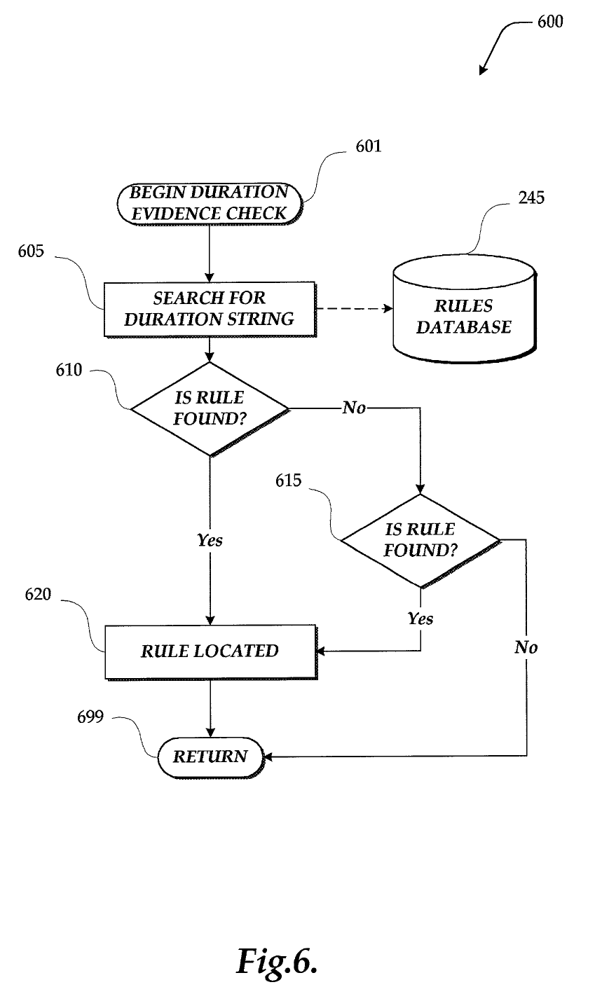

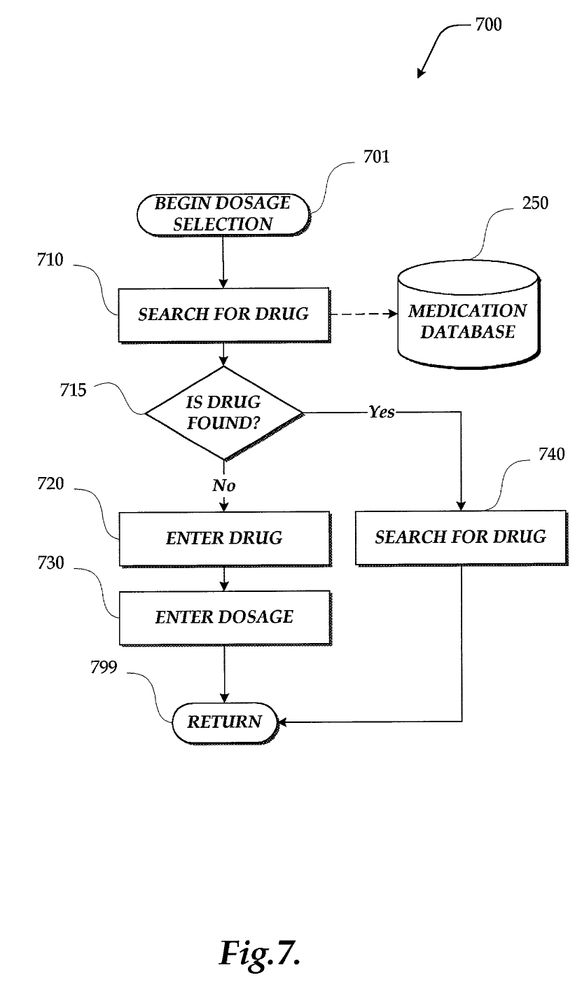

FIGS. 4-8 are flow charts that, taken in conjunction with the system illustrated in FIG. 2, describe processes employed by one embodiment of the invention to provide evidence based information to a provider while outputting a prescription at the time of critical care. The process begins in FIG. 4 at starting block 401, where a provider begins to start the Rx. From starting block 401, processing proceeds to block 405.

At block 405, the provider selects a patient from the list of patients that are scheduled for that day of work. Patient selection is accomplished by a mouse click anywhere on the patient line to identify the patient that is being seen. Basic information is presented on the patient, such as identification, the name of the patient, the general reason for the visit, the appointment time and the doctor that is responsible for said patient. Processing then proceeds to block 410.

At block 410, the indication is selected from a popup menu enabling the provider to choose from a list of standard conditions. An indication is inclusive of standard indications that occur in a health care setting. It will be appreciated by those in the art that the list for indications may be modified from its current form to include regional or global commonalties. The benefit to this approach is that very apparent indications will be quickly accessed which will speed up the overall process of writing the prescription. Processing continues with block 415.

At block 415, a sub-menu to the indication list is presented to the provider regarding the selection for medication. Medications are based off common prescription medications used to treat the indications listed in the form. This has a positive effect in that a base is formulated with which a provider may make further selections as presented later in the application program. The next step after the medication has been selected is to continue with the sub-routine at block 500.

At block 501, the process continues with the indications Rx subroutine at block 505. Block 505 details the search for the indication making a call to the indications database 255. The indications database 255 is searched for all known indications for the particular patient complaint. The process continues to block 510. The provider then selects the indication if the indication database 255 has it displayed and continues with block 515 if selecting “Other” or continues with block 525 if the indication is shown.

At block 515, the process continues with the assumption that an indication has not been found and so the provider must manually enter in the information. The provider selects “Other” from the pop up menu and is then prompted to enter in the type of indication as the process has moved on to block 520. After the provider has entered in the indication, the process continues with block 599 where it will reenter the main process.

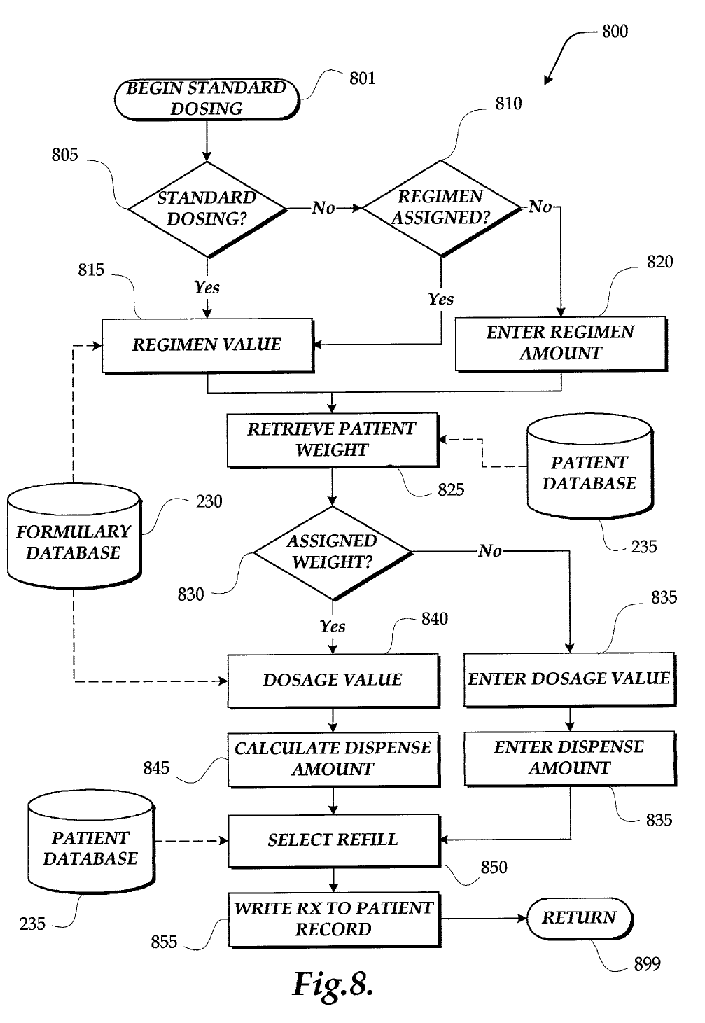

At block 525 a check for evidence occurs and a query to the rules database 245 takes place. The provider database 240 is searched for provider demographic information 535. The provider demographic information is used later in the main process for the prescription writing process. The information is used by block 855 of FIG. 8. The process continues with block 535 where the rules note is searched by querying the rules note database 260. The information retrieved from block 535 is sent to block 540 where the rule note is displayed to the user. The process continues with block 599 where the main process is rejoined. This form of recording helps to insure that the provider was presented with as much information as possible and it will be appreciated by those in the art that should it be desired, it is possible to query the rules notes database, provider database and patient database to chart the records of the case types that have occurred over a given time period.

At block 600, processing continues with the duration evidence check subroutine. From block 601, the process continues with block 605 where a search for the duration string occurs in the rules database 245. The duration string is equivalent to the recommended time a medication is expected to take to clear the indication. The results are forwarded to block 610 where the process branches to block 615 if the rule isn't found or block 620 if the rule is found. At block 620, the rule is located and the result is passed to block 699 where the main process is rejoined.

The process continues with the subroutine at block 700. At block 701, the process searches for a drug as illustrated with block 710 by searching for the drug in a medication database 250. A selection of drugs is presented to the provider from which to make a selection. The medication selected at this point adheres to the previously entered information from previous steps in the process. Processing continues with block 715, where a branch occurs to block 740 if the drug was found or continues with block 720 if no drug was found. At block 720, the provider enters the drug manually and continues the process with block 730 where the dosage is also entered manually. If drugs are found they are displayed as outlined in block 715 and the process continues at block 740 where the provider selects the drug and then returns to the main process at block 799.

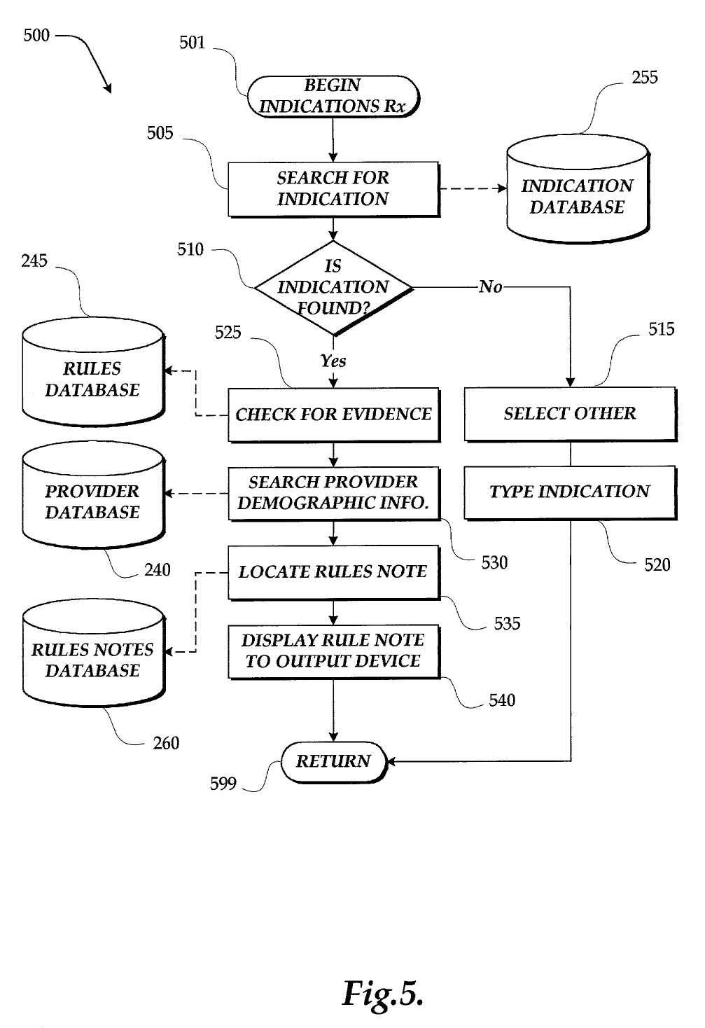

At block 800, the main process enters the standard dosing subroutine. Processing continues from block 801 to block 805 where the provider selects whether standard dosing will be used or not. If standard dosing is selected, processing continues with block 815 or block 810 in not chosen. At block 810, the provider selects whether or not to assign the regimen. If the provider does not choose the regimen the process continues with block 820, where a regimen amount is manually entered by the provider at which point the result continues to block 825. If standard dosing had been selected previously, the regimen value is decided, at block 815, by a query to the formulary database 250 and the result is continued in block 825. At block 825, the patient's weight is retrieved from the patient database 235 and the information is forwarded on to block 830. If the patient did not have a retrievable weight listed in the database the process will split to block 835, where a dosage is manually entered followed by a dispense amount in block 835. From block 835, the refill amount is selected and the prescription is written to the patient record and printed for use. At block 840 the dosage is queried in the formulary database 240 and processing continues with the information of the regimen and patient weight being forwarded to block 845. At block 845, the dispense amount is calculated form the above provided information and then the provider selects the refill quantity from block 850. All information from the proceeding is forwarded to block 855 where the prescription is saved in the patient database 235 and a prescription is issued. Additionally, information retrieved earlier in the overall process from FIG. 5, block 530 is used to fill in information in the prescription regarding the provider. Finally, the subroutine is returned to the main process at block 899.

From block 800, the process can continue to either block 420, 430, 440 or 450. Block 420 is a reset which resets the current activity ant starts again at block 500. Block 430 is a cancel, which sends the provider back to the select patient screen. Block 440 allows the provider to select another patient returning the provider to the select patient screen upon completion of a prescription. Block 450 will print the finished prescription and send the process back to the patient selection screen, block 500.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer based method of providing evidence-based information to a service provider that is in the process of making a decision as to a treatment regimen to be followed, the method comprising the steps of:
(a) prompting the provider to select a medication;
(b) receiving the provider's selection of a medication; and
(c) in response to the provider's selective request, providing evidence-based information on the selected medication on a scaled basis.

2. The method of claim 1, further comprising the steps of:
after step (b) and before step (c), prompting the provider to select an indication that is treatable using the selected medication; and
receiving the provider's selection of an indication;
wherein step (c) comprises providing evidence-based information on the selected medication as applied to treat the selected indication.

3. The method of claim 2, wherein the step of prompting the provider to select an indication comprises providing a list of indications predetermined to be associated with the selected medication.

4. The method of claim 1, further comprising the steps of:
before step (a), prompting the provider to select a condition of a patient to be treated; and
receiving the provider's selection of a condition;
wherein step (a) comprises providing a list of medications predetermined to be associated with the selected condition, from which the provider is prompted to select one medication.

5. The method of claim 4, wherein the step of prompting the provider to select a condition comprises providing a list of predefined conditions, from which the provider is prompted to select one condition.

6. The method of claim 1, further comprising the step of:
after step (b) and before step (c), presenting a summary of the evidence-based information on the selected medication to assist the provider in selectively requesting the evidence-based information on a scaled basis.

7. The method of claim 1, wherein the evidence-based information comprises an article, and step (c) comprises the steps of:
presenting an at least one line summary of available evidence-based information;
presenting a synopsis of the article in response to a first request by the provider;
presenting an abstract of the article in response to a second request by the provider; and
presenting the article itself in response to a third request by the provider.

8. The method of claim 1, wherein the evidence-based information is stored in a predefined database.

9. The method of claim 1, which is implemented on a network.

10. The method of claim 9, wherein the evidence-based information is retrieved over a network.

11. The method of claim 9, wherein the network is the Internet.

12. The method of claim 1, further comprising the step of prompting the provider to store, print, or forward to a designated location over a network the provided evidence-based information.

13. The method of claim 1, further comprising the step of generating a prescription of the selected medication for a patient.

14. The method of claim 13, further comprising the step of displaying a warning to the provider when the selected medication is known to possess medical dangers.

15. The method of claim 14, further comprising the step of generating a selection whereby the provider may abandon the present prescription upon the warning.

16. The method of claim 13, further comprising the step of generating dosing information by calculating the dose of the selected medication using information provided on a patient.

17. A computer based method of providing evidence-based information to a service provider that is in the process of making a decision as to a treatment regimen to be followed, the method comprising the steps of:
(a) prompting the provider to select a treatment regimen;
(b) receiving the provider's selection of a treatment regimen; and
(c) in response to the provider's selective request, providing evidence-based information on the selected treatment regimen on a scaled basis.

18. The method of claim 17, further comprising the step of:
after step (b) and before step (c), presenting a summary of the evidence-based information on the selected treatment regimen to assist the provider in selectively requesting the evidence-based information on a scaled basis.

19. The method of claim 17, wherein the evidence-based information comprises an article, and step (c) comprises the steps of:
presenting an at least one line summary of available evidence-based information;
presenting a synopsis of the article in response to a first request by the provider;
presenting an abstract of the article in response to a second request by the provider; and
presenting the article itself in response to a third request by the provider.

20. The method of claim 17, further comprising the step of:
providing a list of lab tests predetermined to be associated with the selected treatment regimen, from which the provider is prompted to select one or more lab tests.

21. The method of claim 17, further comprising the step of:
providing a list of radiology examinations predetermined to be associated with the selected treatment regimen, from which the provider is prompted to select one or more radiology examinations.

22. The method of claim 17, further comprising the step of generating treatment instructions for a patient.

23. The method of claim 17, wherein the treatment regimen is a medication.

24. The method of claim 23, wherein the step of prompting the provider to select a medication comprises providing a list of medications.

25. The method of claim 17, which is implemented on a network.

26. The method of claim 25, wherein the evidence-based information is retrieved over a network.

27. The method of claim 25, wherein the network is the Internet.

28. The method of claim 17, further comprising the step of prompting the provider to store, print, or forward to a designated location over a network the provided evidence-based information.

29. A computer-readable medium having computer-executable instructions for providing evidence-based information to a service provider that is in the process of making a decision as to a treatment regimen to be followed, the medium being adapted for carrying out the method of any one of claims 1 through 28.

30. A computer apparatus for providing evidence-based information to a service provider that is in the process of making a decision as to a treatment regimen to be followed, the apparatus comprising:
means for prompting the provider to select a medication;
means for receiving the provider's selection of a medication; and
means for providing evidence-based information on the selected medication on a scaled basis in response to the provider's selective request.

31. The apparatus of claim 30, wherein the means for providing evidence-based information comprises a predefined database that stores the evidence-based information.

32. The apparatus of claim 30, wherein the apparatus is a part of a network.

33. The apparatus of claim 32, wherein the network is the Internet.

34. The apparatus of claim 30, further comprising means for prompting the provider to store, print, or forward to a designated location over a network the provided evidence-based information.

35. The apparatus of claim 30, further comprising means for generating a prescription of the selected medication for a patient.

36. The apparatus of claim 35, further comprising means for generating dosing information by calculating the dose of the selected medication using information provided on a patient.

36. A computer system for providing evidence-based information to a service provider that is in the process of making a decision as to a treatment regimen to be followed, the system comprising:
a user interface including input means and output means;
a processing unit coupled to the user interface; and
a storage medium coupled to the processing unit;
wherein the processing unit being operable under control of program code stored in the storage medium to:
prompt the provider via the output means to select a medication;
receive the provider's selection of a medication via the input means; and
in response to the provider's selective request via the input means, provide evidence-based information of the selected medication on a scaled basis via the output means.

37. The system of claim 36, wherein the processing unit is further operable to:
prompt the provider via the output means to select a condition of a patient to be treated; and
receive the provider's selection of a condition via the input means;
wherein the processing unit is operable to present a list of medications predetermined to be associated with the selected condition via the output means, from which list the provider is prompted to select one medication via the input means.

38. The system of claim 36, wherein the processing unit is further operable to generate a prescription of the selected medication for a patient including dosing information suited for the patient.

39. The system of claim 38, wherein the processing unit is further operable to calculate standard dosing based on the selected medication and physiological information of the patient.

40. The system of claim 39, wherein the processing unit is further operable to prompt the provider via the output means to select standard dosing or manual dosing, wherein if the provider selects standard dosing via the input means, the unit calculates standard dosing of the selected medication, and if the provider selects manual dosing via the input means, the unit receives manual dosing that the provider enters via the input means.

41. The system of claim 36, wherein the processing unit is further operable to output the generated prescription including the dosing information via the output means.

42. The system of claim 36, wherein the processing unit is further operable to output the generated treatment instructions for a patient.

43. The system of claim 36, which is a part of a network.

44. The system of claim 43, wherein the network is the Internet.

45. The system of claim 36, wherein the storage medium comprises a rules database, medication database, indications database, and rules notes database.

46. The system of claim 36, wherein the rules database includes a predefined collection of evidence-based information, each piece of the evidence-based information comprising an article and being subdivided into a synopsis of the article, an abstract of the article, and the article itself, the synopsis, the abstract, and the article itself being independently retrievable from the rules database.

47. The system of claim 46, wherein the medication database includes a predefined collection of records on common dosages, physical forms, and maximum dosages of medications.

48. The system of claim 46, wherein the indication database includes a predefined collection of records on indications in association with medications that are used to treat the indications.

49. The system of claim 46, wherein the rules notes database is adapted to store records of the provider's actions as indicated by the provider's input into the system using the input means.

50. The system of claim 46, wherein the storage medium further comprises a formulary database.

51. The system of claim 50, wherein the formulary database includes a predefined collection of records on formulas, intended uses, and methods of preparation of medications.

52. The system of claim 46, wherein the storage medium further comprises a provider database.

53. The system of claim 52, wherein the provider database includes a collection of provider records, each of the provider records comprising information selected from the group consisting of a name, Drug Enforcement Agency number, and email address of each provider.

54. The system of claim 46, wherein the storage medium further comprises a patient database.

55. The system of claim 54, wherein the patient database includes a collection of patient records, each of the patient records comprising information selected from the group consisting of a name, birth date, gender, insurance information, weight, height, treatment history, and medical history of each patient.
